(19) United States
(12) Patent Application Publication
(10) Pub. No.: US 2018/0336248 A1
(43) Pub. Date: Nov. 22, 2018

(54) DISTRIBUTED IN-MEMORY-BASED COMPLEX DATA PROCESSING SYSTEM AND METHOD

(71) Applicant: Altibase Corp., Seoul (KR)

(72) Inventors: Kwang Ik Seo, lncheon (KR); Joon Ho Park, Seoul (KR); Jong Jeong Lee, Gyeonggi-do (KR); Jong Min Kim, Seoul (KR)

(21) Appl. No.: 15/689,259

(22) Filed: Aug. 29, 2017

(30) Foreign Application Priority Data
May 18, 2017 (KR) 10-2017-0061641

(51) Int. Cl. G06F 17/30; G06F 12/0817

(52) U.S. Cl. CPC G06F 17/30516; G06F 12/0817; G06F 17/3061

(57) ABSTRACT

A distributed in-memory-based complex stream data processing system collects complex high-speed stream data generated from various data sources and classifies and processes the collected complex high-speed stream data in real time. In this case, at least one in-memory database (DB) is used.

### CROSS-REFERENCE TO RELATED APPLICATION

This application claims the benefit of Korean Patent Application No. 10-2017-0061641, filed on May 18, 2017, in the Korean Intellectual Property Office, the disclosure of which is incorporated herein in Its entirety by reference.

### BACKGROUND

### 1. Field

One or more embodiments relate to a method of distributing and processing a complex stream inducing large-capacity data, big data, and the like, in real time.

### 2. Description of the Related Art

Various unstructured and semistructured data analyses occurring in an Internet of Things (IoT) environment, multi-dimensional analysis of ultra large-capacity billing information in a communication field, real-time analysis of ultra high-speed trading information in a financial field, or complex stream analysis for accident sensing, disaster prevention, and the like in public and service fields have recently become important.

When stream data having ultra large-capacity and having meaning only with respect to a specific event is processed by storing data in a database management system (DBMS) and then determining whether the data has meaning only with respect to a specific event by referring to the data, as in a current operation, significant performance degradation and inefficient management may occur.

### SUMMARY

One or more embodiments include a high-speed stream big data processing method capable of managing and analyzing, in real time, big data that is generated from various data sources at high speed. One or more embodiments include a complex stream data processing system and method in which not only structured data but also semistructured and unstructured stream data are processed at ultra high speed.

Additional aspects will be set forth in part in the description which follows and, in part, will be apparent from the description, or may be learned by practice of the presented embodiments.

According to one or more embodiments, a distributed in-memory-based complex stream data processing system includes a data collector configured to collect complex high-speed stream data generated from various data sources; a data distributed processor configured to classify the collected complex high-speed stream data according to a presence or absence of a shape or a possibility or impossibility of calculation to classify data having a shape and being calculable as structured data, data having a shape but being incalculable as semistructured data, and data having no shape and being incalculable as unstructured data and to process the classified data, in real time; and at least one in-memory database (DB) configured to store the structured data, the semistructured data, the unstructured data, and a result of analyzing the complex high-speed stream data, wherein each of the at least one in-memory DB includes an analyzer configured to analyze the complex high-speed stream data.

The data collector may further include a client application, and the distributed in-memory-based complex stream data processing system may further include a meta node configured to analyze a user query to determine whether the user query is a shard query including a shard object, and to distribute data into each of the at least one in-memory DB according to a shard key and process the distributed data when the user query is a shard query; and a shard library provided in the client application in a library form to serve as a coordinator between the client application and the at least one in-memory DB, to transmit the user query to the meta node, and to receive information of the at least one in-memory DB registered in the meta node to connect the data collector to the at least one in-memory DB.

When the distributed in-memory-based complex stream data processing system is implemented in a server-side sharding mode, the client application may be connected to the meta node, the meta node creates a session, and, when the client application requests the meta node for the shard query, a shard connection may be created for each session with respect to the at least one in-memory DB registered in the meta node.

When the distributed in-memory-based complex stream data processing system is implemented in a client-side sharding mode, a shard library provided in the client application may access the meta node to receive information of each of the at least one in-memory DB registered in the meta node, and may create a shard connection when the shard library is connected to all of the at least one in-memory DB.

The complex high-speed stream data may include sensor data, XML-type data, HTML-type data, text data, audio data, and video data.

According to one or more embodiments, a distributed in-memory-based complex stream data processing method includes collecting a complex stream generated from various data sources in a data collector; classifying the collected complex stream as structured data, semistructured data, and unstructured data, in real time, and distributing and processing the classified complex stream, in a data distributed processor; storing the structured data, the semistructured data, the unstructured data, and a result of processing the complex stream, in at least one in-memory DB; and distributing the complex stream in the at least one in-memory DB according to a sharding method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of an internal structure of a distributed in-memory-based complex stream data processing system according to an embodiment of the present invention;

FIG. 2 is a schematic diagram illustrating an environment for receiving complex high-speed stream data, according to an embodiment of the present invention;

FIG. 3 is a schematic diagram illustrating an example of performing sharding in a distributed in-memory-based complex stream data processing system, according to an embodiment of the present invention;

FIG. 4 is a schematic diagram illustrating an operation of a distributed in-memory-based complex stream data processing system, according to an embodiment of the present invention; and

FIG. 5 is a flowchart of processing complex stream data in a distributed in-memory-based complex stream data processing system, according to an embodiment of the present invention.

### DETAILED DESCRIPTION

Embodiments of the present invention are described in detail herein with reference to the accompanying drawings so that this disclosure may be easily performed by one of ordinary skill in the art to which the present invention pertain. The present invention may, however, be embodied in many different forms and should not be construed as being limited to the embodiments set forth herein.

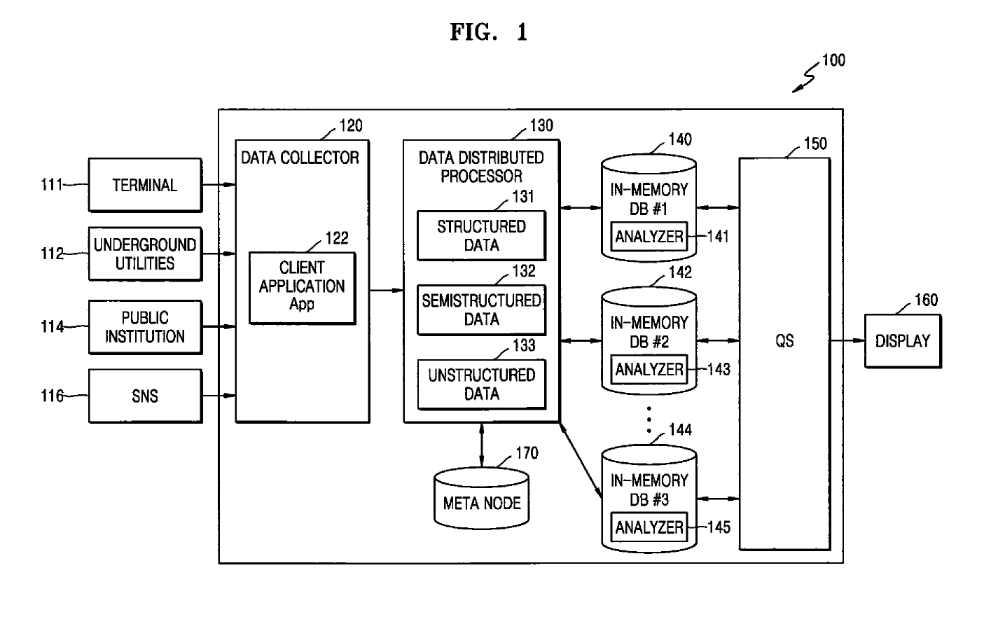

FIG. 1 is a block diagram of an internal structure of a distributed in-memory-based complex stream data processing system 100 according to an embodiment of the present invention.

According to an embodiment of the present invention, the distributed in-memory-based complex stream data processing system 100 may include a data collector 120, a data distributed processor 130, at least one in-memory database (DB), namely, in-memory DBs 140, 142, and 144, and analyzers 141, 143, and 145, and may further include a display 160.

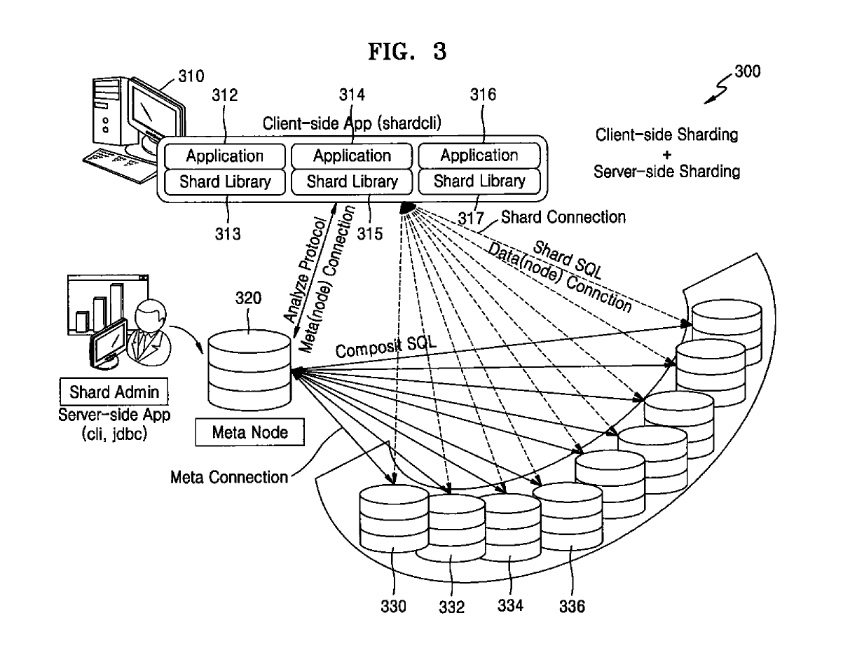

According to an embodiment of the present invention, the distributed in-memory-based complex stream data processing system 100 may further include a client application 122 and a meta node 170 in order to perform sharding. An embodiment in which a distributed in-memory-based complex stream data processing system performs sharding will be described later with reference to FIG. 3.

The data collector 120 collects complex high-speed stream data generated from various data sources. The complex high-speed stream data includes sensor data, XML-type data, HTML-type data, text data, audio data, and video data. Examples of the various data sources include data received from a terminal 111, data received from a sensor provided in underground utilities 112, data received from a sensor provided in a pubic institution 114, and data received from a social network service (SNS) 116. Examples of the terminal 111 include a notebook, a computer, a hand-held device, a wearable device, and an Internet of Things (IoT) device.

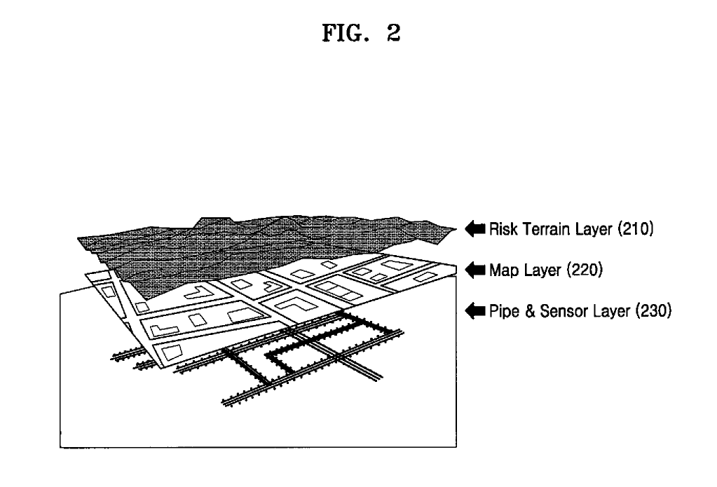

FIG. 2 is a schematic diagram illustrating an environment for receiving complex high-speed stream data, according to an embodiment of the present invention.

The environment for receiving complex high-speed stream data illustrated in FIG. 2 may be displayed on the display 160 or the like. The environment for receiving complex high-speed stream data illustrated in FIG. 2 may be roughly divided into three layers. A top layer 210 indicates a layer representing an actual tomography. A middle layer 220 indicates a map-type layer including cadastral map information and the like. A bottom layer 230 is a layer representing an arrangement plan of a sensor provided in a pipe and the like laid underground.

According to an embodiment of the present invention, referring to FIG. 2, when the data collector 120 receives an SNS tweet message and simultaneously collects location information of the terminal 111 that has transmitted the SNS tweet message, the data distributed processor 130 displays the location information of the terminal 111 on the top layer 210 and correlates map information of the middle layer 220 with the location information. The data distributed processor 130 may also process data collected from the SNS 116 by using a probability model and then store a location of a corresponding mapand sensor information of the sensor provided in the pipe and the like laid underground in association with each other.

According to an embodiment of the present invention, the data distributed processor 130 classifies the complex high-speed stream data collected by the data collector 120 according to presence or absence of a shape or possibility or impossibility of calculation. The data distributed processor 130 may classify data having a shape and being calculable as structured data, data having a shape but being incalculable as semistructured data, and data having no shapes and being incalculable as unstructured data and process the classified data, in real time.

According to an embodiment of the present invention, the data distributed processor 130 may perform voice-to-text conversion on voice data included in collected audio data and utilize a result of the voice-to-text conversion as unstructured data.

According to an embodiment of the present invention, the data distributed processor 130 may classify the collected complex high-speed stream data according to data types and perform distributed-processing on the classified complex high-speed stream data. For example, the data distributed processor 130 may distribute the collected complex high-speed stream data as the structured data, the semistructured data, and the unstructured data and process the distributed complex high-speed stream data.

According to an embodiment of the present invention, the data distributed processor 130 may perform topic modeling by extracting only a noun from collected usage log data for an SNS by using a morpheme analyzer and then extracting a collection of topics that form a theme via Latent Dirichlet Allocation (LDA). In addition, the data distributed processor 130 may perform an analysis by calculating a number of times a word is derived from the topic modeling during each time zone and by converting the calculated number of times into standardized time series data.

According to an embodiment of the present invention, the data distributed processor 130 may classify the collected data according to time sections and perform distributed-processing on the classified data. In this case, the time sections may be classified as 12 hours, 24 hours, one week, one month, and a user's setting.

According to an embodiment of the present invention, the data distributed processor 130 may classify the collected data according to associated topics and perform distributed-processing on the classified data. In this case, examples of the associated topics include a sink hole, leakage, roads, washout, a water pipe, burying, an accident, and ground sinking.

According to an embodiment of the present invention, the data distributed processor 130 may classify the collected data according to disaster types and perform distributed-processing on the classified data. In this case, examples of the disaster types include infectious disease, fire, heavy snow, landslide, earthquake, typhoon, yellow dust, and flood.

According to an embodiment of the present invention, the data distributed processor 130 may process the collected data by using a Seasonal-Trend Decomposition Procedure based on Loess (STL), classify the processed data according to symptoms, and process the classified data. The STL is a method of breaking data down into a trend component, a seasonal variation, and an irregular variation and analyzing time-series data.

According to an embodiment of the present invention, the data distributed processor 130 may distribute and process the collected data, based on various probability models. Examples of the various probability models include a correlation function of processing one piece of stream data at a time in simple processing and correlating a plurality of simultaneous event streams with each other, a pattern matching function of consecutively matching correlations between a plurality of events and detecting a pattern in real time, a filtering function of separating a single stream by occurrence time according to at least one condition, pattern, or regular expression during event processing, and an aggregate function of combining consecutively-occurring several event sources and collecting and processing a result of the combination as valuable information.

According to an embodiment of the present invention, the data distributed processor 130 may classify the collected data according to a criterion sat by a user and distribute and process the classified data.

The in-memory DBs 140, 142, and 144 may distribute and store the data collected by the data collector 120. The in-memory DBs 140, 142, and 144 may store structured data 131, semistructured data 132, and unstructured data 133 obtained by the classification by the data distributed processor 130 and store a result of processing the structured data 131, the semistructured data 132, and the unstructured data 133. The in-memory DBs 140, 142, and 144 may also store necessary data extracted from the semistructured data 132 and the unstructured data 133. The necessary data includes pattern data common to the semistructured data 132 and the unstructured data 133, data associated with a specific event, or data obtained via filtering performed by the analyzers 141, 143, and 145 and another analyzer 150 by using a statistical technique and a data-mining technique.

According to an embodiment of the present invention, the in-memory DBs 140, 142, and 144 may further include the analyzers 141, 143, and 145 analyzing the complex high-speed stream data, respectively, or may perform communication with the analyzer 150 in a wired/wireless communication form.

According to an embodiment of the present invention, when the analyzers 141, 143, and 145 are included in the in-memory DBs 140, 142, and 144, the analyzers 141, 143, and 145 may perform filtering on the data stored in the in-memory DBs 140, 142, and 144 by using a statistical technique and a data-mining technique.

According to an embodiment of the present invention, the analyzer 150 may perform filtering on the data received from the in-memory DBs 140, 142, and 144 by using a statistical technique and a data-mining technique, while communicating with the in-memory DBs 140, 142, and 144 by wire or wirelessly.

The analyzers 141, 143, 145, and 150 may use various probability models. In this case, the various probability models include a correlation function of processing one piece of stream data at a time in simple processing and correlating a plurality of simultaneous event streams with each other, a pattern matching function of consecutively matching correlations between a plurality of events and detecting a pattern in real time, a filtering function of separating a single stream by occurrence time according to at least one condition, pattern, or regular expression during event processing, and an aggregate function of combining consecutively-occurring several event sources and collecting and processing a result of the combination as valuable information.

The analyzers 141, 143, 145, and 150 may display results of the analyses on the display 160 and may feed the results of the analyses back to the data distributed processor 130.

The analyzers 141, 143, 145, 150 may use a topic modeling technique to process the data collected by the data distribution processor 130, and may further include a function of additionally combining and classifying the distributed and processed data.

FIG. 3 is a schematic diagram illustrating an example of performing sharding in a distributed in-memory-based complex stream data processing system 300, according to an embodiment of the present invention. The example of performing sharding will be described with reference to FIG. 1.

Sharding is a scale-out technology of distributing data stored in a single DB into several DBs and storing and processing the distributed data. The sharding technology may be generally divided into a server-side sharding method of separating and processing date by using a coordinator, and a client-side sharding method of separating and processing data in an application.

According to an embodiment of the present invention, the distributed in-memory-based complex stream data processing system 300 may support both the server-side sharding and the client-side sharding. The distributed in-memory-based complex stream data processing system 300 may be implemented to select only server-side sharding or client-side sharding as necessary.

According to an embodiment of the present invention, the distributed in-memory-based complex stream data processing system 300 includes client applications 312, 314, and 316 installable in the data collector 120 of FIG. 1, and further includes shard libraries 313, 315, and 317 respectively provided for the client applications 312, 314, and 316, a meta node 320, and at least one in-memory DB, namely, in-memory DBs 330, 332, 334, and 336.

According to an embodiment of the present invention, the meta node 320 manages the in-memory DBs 330, 332, 334, and 336 and sharding information, analyzes a user query, and performs a coordinator role, such as provision of an integrated query during server-side sharding. The meta node 320 may also perform a function of re-distributing data to the in-memory DBs 330, 332, 334, and 336.

According to an embodiment of the present invention, the shard libraries 113, 115, and 117 are provided in a client terminal in a library form and perform sharding and provide the same API interface as an existing open DB connectivity (ODBC).

According to an embodiment of the present invention, the shard libraries 313, 315, and 317 may perform a coordinate role between the client applications 312, 314, and 316 and the in-memory DBs 330, 332, 334, and 336.

According to an embodiment of the present invention, the distributed in-memory-based complex stream data processing system 300 may still have an entirely-improved performance even when the number of in-memory DBs 330, 332, 334, and 336 increases during server-side sharding. In addition, the distributed in-memory-based complex stream data processing system 300 may not correct the client applications 312, 314, and 316 even when changing a data distribution policy.

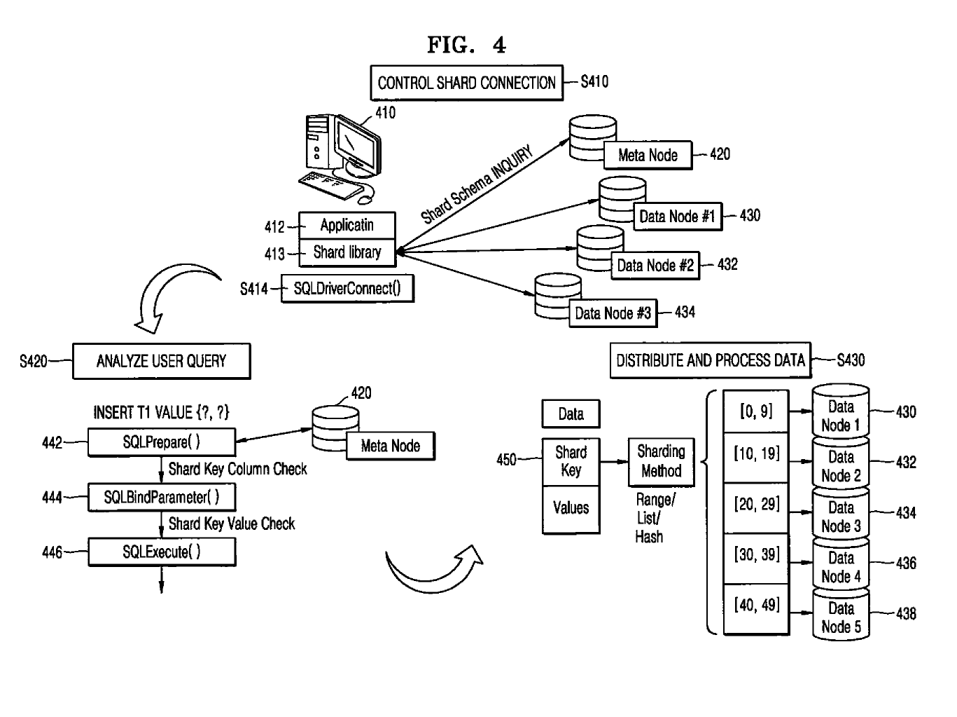

FIG. 4 is a schematic diagram illustrating an example of supporting server-side sharding and client-side sharding in a distributed in-memory-based complex stream data processing system, according to an embodiment of the present invention.

An embodiment of the present Invention in which the complex stream data processing system supports server-side sharding is as follows.

An application 412 provided in the data collector 120 of FIG. 1 or a client terminal 410 attempts to access a meta node 420 via a shard library 413. The application 412 may access to the meta node 420 in the same method as a general DB accessing method.

The meta node 420 creates a session. The application 412 requests the meta node 420 for a user query including a shard object.

An example of determining whether the user query is a shard query including a shard object is as follows.

/* after a node is completely configured, a table is created in each node */

CREATE TABLE t1(id INTEGER, name VARCHAR(50));

/* T1 is set as a shard table */
EXEC DBMS_SHARD.SET_SHARD_TABLE(‘SYS’, ‘T1’, ‘R’, ‘ID’, ‘NODE1’);
EXEC DBMS_SHARD.SET_SHARD_RANGE(‘SYS’, ‘T1’, 3, ‘NODE2’);
EXEC DBMS_SHARD.SET_SHARD_RANGE(‘SYS’, ‘T1’, 6, ‘NODE3’);
/* Data is input to each node */
INSERT INTO t1 VALUES(1, ‘Kim’);
INSERT INTO t1 VALUES(2, ‘Lee’);
INSERT INTO t1 VALUES(3, ‘Park’);
INSERT INTO t1 VALUES(4, ‘Choi’);
INSERT INTO t1 VALUES(5, ‘Jeong’);
INSERT INTO t1 VALUES(6, ‘Kang’);
INSERT INTO t1 VALUES(7, ‘Joe’);
INSERT INTO t1 VALUES(8, ‘Yoon’);
INSERT INTO t1 VALUES(9, ‘Jang’);

/* Query test */
iSQL> SELECT * FROM t1 WHERE id = 2;
Because an inquiry is possible only in a specific node, a normal operation is
performed.

| | |
|---|---|
| ID | NAME |

-------------------------------------------------------------------

| | |
|---|---|
| 2 | Lee |

1 row selected.
iSQL> SELECT * FROM t1; --Since T1 is a shard table , an error is generated
during a single query inquiry.
[ERR-E1385 : The shard table is only available inside the shard view.:
0001 : SELECT * FROM T1
]
iSQL> SHARD SELECT * FROM t1; -- When all distributed and stored pieces of
data are checked, a “SHARD” sentence is used.

| | |
|---|---|
| ID | NAME |

-------------------------------------------------------------------

| | |
|---|---|
| 7 | Joe |
| 8 | Yoon |
| 9 | Jang |
| 1 | Kim |
| 2 | Lee |
| 3 | Park |
| 4 | Choi |
| 5 | Jeong |
| 6 | Kang |

9 rows selected.
iSQL> SELECT * FROM t1 WHERE id = 2 OR id = 3; -- Because an inquiry is
possible only in a specific node, a normal operation is performed.

| | |
|---|---|
| ID | NAME |

-------------------------------------------------------------------

| | |
|---|---|
| 2 | Lee |
| 3 | Park |
| 2 rows selected. | |

iSQL> SELECT COUNT(*) FROM t1; -- Because a sum of all nodes needs to be
obtained and inquired, an error is generated when a single query is used.
[ERR-E1385 : The shard table is only available inside the shard view.:
0001 : SELECT COUNT(*) FROM T1
]
iSQL> SHARD SELECT COUNT(*) FROM t1;
--Because a sum of all nodes needs to be obtained and inquired, a “SHARD”
sentence is used during the inquiry.
COUNT(*)
----------------------
3
3
3
3 rows selected.
iSQL> SELECT SUM(c1) FROM SHARD(SELECT COUNT(*) c1 FROM t1);
--Because a sum of all nodes needs to be obtained and inquired, a “SHARD”
sentence is used during the inquiry.
SUM(C1)
-----------------------
9
1 row selected.

The meta node 420 generates a shard connection with respect to all of in-memory DBs 430, 432, 434, 436, and 438 registered in the meta node 420, for each session. When a session is terminated, the shard connection is also terminated. In operation S410, the meta node 420 controls the shard connection as described above. In operation S420, the met node 420 analyzes a user query input during this process as follows.

The meta node 420 analyzes the user query requested by the application 412. When the user query is a shard query, a result of the analysis is created, and a plan tree is created by performing a high-quality optimization by the result of the analysis. The meta node 420 may distinguish a case where the user query is a shard query from a case where the user query is not a shard query and process the distinguished cases. When the user query is not a shard query, the meta node 420 processes the user query by serving as a coordinator.

When the shard query is performed, the meta node 420 may perform the created plan tree. When the meta node 420 inquires a plan after performing the shard query, the metal node 420 may check a plan of a shard SQL performed by each of the in-memory DBs 430, 432, 434, 436, and 438. The meta node 420 feeds a result of performing the shard query back to the application 412.

An embodiment of the present invention in which the complex stream data processing system supports client-side sharding is as follows.

When client-side sharding is performed, the meta node 420 creates meta information including schema information of in-memory DBs via analysis only when the application 412 prepares an inquiry for the first time as indicated by reference numeral 442. When the application 412 accesses the met node 420 initially one time, the application 412 ascertains information about what tables are stored in the in-memory DBs 430, 432, and 434, via a Shard Schema inquiry. Only the initial one analysis is required, and an additional analysis is not required.

The meta node 420 may repeatedly perform an inquiry by using only the created meta information and bind information of the application 412. As a result, performance expandability of client-side sharding is maintained, and still there is no need to correct or rewrite an application.

When the user query that was analyzed s a shard query including a shard object, the meta node 420 distributes data into the in-memory DBs 430, 432, 434, 436, and 438 according to a shard key 450, and processes the distributed data. According to an embodiment of the present invention, the shard key 450 may be used according to a method, such as Range, List, or Hash.

When a hybrid sharding system performs client-side sharding and the application 412 calls a SQLDrveConnect( ) function S414 to the meta node 420, the shard library 413 is connected to the meta node 420. The shard library 413 receives information of a of the in-memory DBs 430, 432, 434, 436, and 438 serving as data nodes registered in the meta node 420. Thereafter, when the shard library 413 is connected to all of the in-memory DBs 430, 432, 434, 436, and 438, the shard library 413 informs the application 412 that the connections were succeeded. However, when any one of the in-memory DBs 430, 432, 434, 436, and 438 fails to connect, connections of already successfully-connected in-memory DBs are terminated, and the shard library 413 informs the application 412 that the connections failed.

When the shard connection is created, the application 412 calls a SQLPrepare( ) function 442. The shard library 413 transmits the user query to the meta node 420. The meta node 420 analyzes the user query received by the application 412 to determine whether the user query is a shard query, and transmits a result of the analysis to the shard library 413.

When the user query is a query unexecutable by the shard library 413, the meta node 420 transmits an error message to the application 412. The result of the analysis of the user query may include, for example, whether the user query is a shard query, a list of in-memory DBs capable of performing a shard query when the user query is the shard query, and a method of interpreting a host parameter and a bind value associated with a shard key.

When the shard query is analyzed, the shard library 413 executes the SQLPrepare( ) function 442 with respect to the in-memory DBs included in the result of the analysis of the user query. When the application 412 calls a SQLBindParameter( ) function 444, the shard library 413 executes the SQLBindParameter( ) function 444 with respect to the in-memory DBs included in the result of the analysis of the user query.

When the application 412 executes a SQLExecuts( ) 446, the shard library 413 searches for a value associated with the shard key from bind values and then analyzes the bind value to select one of the in-memory DBs 430, 432, 434, 436, and 438 that is to perform the shard query. The the shard library 413 executes the SQLExecute( ) 446 with respect to the selected in-memory DB and transmits a result of the execution to the application 412.

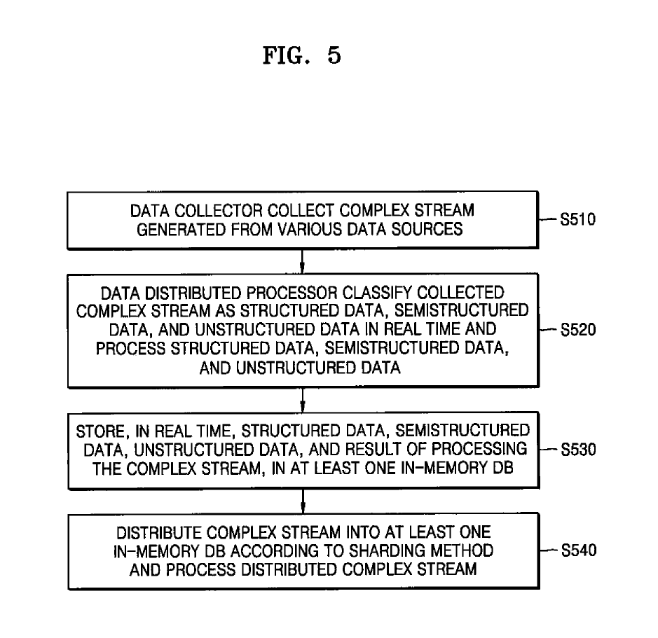

FIG. 5 is a flowchart of processing complex stream data in a distributed in-memory-based complex stream data processing system, according to an embodiment of the present invention.

In operation S510, a data collector collects a complex stream generated from various data sources. The complex steam includes all of various types of data, such as big data, video data, audio data, a text, an SNS tweet message, sensor data, HTML data, and XML data.

In operation S520, a data distributed processor classifies the collected complex stream as structured data, semistructured data, and unstructured data in real time, and distributes and stores the collected complex stream in at least one in-memory DB. The data distribution processor may distribute the received complex stream according to data types, event types, or a preset criterion and process the distributed complex stream.

In operation S530, the at least one in-memory DB stores, in real time, the structured data, the semistructured data, the unstructured data, and a result of processing the complex stream. In addition, received data may be combined or classified via an analyzer.

In operation S540, the distributed in-memory-based complex stream data processing system may distribute the complex stream collected by the data collector into the at least one in-memory DB according to a sharding method and may process the distributed complex stream.

According to an embodiment of the present invention, a distributed in-memory-based complex stream data processing system may improve a complex high-speed stream big data processing rate and support an analysis in real time, by using in-memory DBs. Moreover, the distributed in-memory-based complex stream data processing system may analyze and store structured, semistructured, and unstructured data in real time.

The present invention can be embodied as computer readable codes on a computer readable recording medium. The computer readable recording medium is any type of recording device that stores data which can thereafter be read by a computer system. Examples of the computer-readable recording medium include ROM, RAM, CD-ROMs, magnetic tapes, floppy discs, and optical data storage media. The computer readable recording medium can also be distributed over network coupled computer systems so that the computer readable code is stored and executed in a distributive manner.

While the inventive concept has been particularly shown and described with reference to exemplary embodiments thereof, it will be understood by those of ordinary skill in the art that various changes in form and details may be made therein without departing from the spirit and scope as defined by the following claims.

What is claimed is:

1. A distributed in-memory-based complex stream data processing system comprising:
a data collector configured to collect complex high-speed stream data generated from various data sources;
a data distributed processor configured to classify the collected complex high-speed stream data according to a presence or absence of a shape or a possibility or impossibility of calculation to classify data having a shape and being calculable as structured data, data having a shape but being incalculable as semistructured data, and data having no shape and being incalculable as unstructured data and to process the classified data, in real time; and
at least one in-memory database (DB) configured to store the structured data, the semistructured data, the unstructured data, and a result of analyzing the complex high-speed stream data, wherein each of the at least one in-memory DB comprises an analyzer configured to analyze the complex high-speed stream data.

2. The distributed in-memory-based complex stream data processing system of claim 1, wherein
the data collector further comprises a client application, and
the distributed in-memory-based complex stream data processing system further comprises:
a meta node configured to analyze a user query to determine whether the user query is a shard query including a shard object, and to distribute data into each of the at least one in-memory DB according to a shard key and process the distributed data when the user query is a shard query; and
a shard library provided in the client application in a library form to serve as a coordinator between the client application and the at least one in-memory DB, to transmit the user query to the meta node, and to receive information of the at least one in-memory DB registered in the meta node to connect the data collector to the at least one in-memory DB.

3. The distributed in-memory-based complex stream data processing system of claim 2, wherein, when the distributed in-memory-based complex stream data processing system is implemented in a server-side sharding mode, the client application is connected to the meta node, the meta node creates a session, and, when the client application requests the meta node for the shard query, a shard connection is created for each session with respect to the at least one in-memory DB registered in the mete node.

4. The distributed in-memory-based complex stream data processing system of claim 2, wherein, when the distributed in-memory-based complex stream data processing system is implemented in a client-side sharding mode, a shard library provided in the client application accesses the meta node to receive information of each of the at least one in-memory DB registered in the mete node, and creates a shard connection when the shard library is connected to al of the at least one in-memory DB.

5. The distributed in-memory-based complex stream data processing system of claim 2, wherein the complex high-speed stream data includes sensor data, XML-type data, HTML-type data, text data, audio data, and video data.

6. The distributed in-memory-based complex stream data processing system of claim 5, wherein voice data included in the audio data undergoes voice-to-text conversion to be utilized as unstructured data.

7. The distributed in-memory-based complex stream data processing system of claim 5, wherein the video data is utilized as unstructured data, based on image registration or feature point extraction, and is implemented such that video classification is additionally performed.

8. The distributed in-memory-based complex stream data processing system of claim 1, wherein the analyzer performs filtering with respect to the semistructured data and the unstructured data by using a statistical technique and a data-mining technique.

9. The distributed in-memory-based complex stream data processing system of claim 1, wherein the analyzer supports at least one function from among a correlation function of processing one piece of stream data at a time in simple processing and correlating a plurality of simultaneous event streams with each other, a pattern matching function of consecutively matching correlations between a plurality of events and detecting a patter in real time, a filtering function of separating a single stream according to an occurrence time according to at least one condition, pattern, or regular expression during event processing, and an aggregate function of combining several consecutively-occurring event sources and collecting and processing a result of the combination as valuable information.

10. The distributed in-memory-based complex stream data processing system of claim 1, wherein the complex high-speed stream data comprises data received from a sensor and usage log data for a social network service (SNS).

11. The distributed in-memory-based complex stream data processing system of claim 10, wherein the analyzer performs topic modeling by extracting only a noun from the usage log data for the SNS by using a morpheme analyzer and then extracting a collection of topics that form a theme via Latent Dirichlet Allocation (LDA) and performs analysis by calculating a number of times a word is derived from the topic modeling during each time zone and converting the calculated number of times into standardized time series data.

12. The distributed in-memory-based complex stream data processing system of claim 1, wherein the structured data comprises sensor data received from a sensor laid underground, and the structured data, the semistructured data, and the unstructured data are classified and combined according to a specific event.

13. A distributed in-memory-based complex stream data processing method comprising:
collecting a complex stream generated from various data sources in a data collector,
classifying the collected complex stream as structured data, semistructured data, and unstructured data, in real time, and distributing and processing the classified complex stream, in a data distributed processor;
storing the structured data, the semistructured data, the unstructured data, and a result of processing the complex stream, in at least one in-memory DB; and
distributing the complex stream in the at least one in-memory DB according to a sharding method.
